(19) United States
(12) Patent Application Publication
(10) Pub. No.: US 2014/0281491 A1
(43) Pub. Date: Sep. 18, 2014

(54) IDENTITY ESCROW MANAGEMENT FOR MINIMAL DISCLOSURE CREDENTIALS

(71) Applicant: Microsoft Corporation, (US)

(72) Inventors: Greg Zaverucha, Redmond, WA (US); Christian Paquin, Bellevue, WA (US); Melissa E. Chase, Seattle, WA (US)

(73) Assignee: Microsoft Corporation, Redmond, WA (US)

(21) Appl. No.: 13/834,286

(22) Filed: Mar. 15, 2013

(51) Int. Cl. H04L 29/06

(52) U.S. Cl. CPC H04L 63/0421
USPC 713/155

(57) ABSTRACT

The subject disclosure is directed towards identity escrow management where anonymous online users can be de-anonymized if certain conditions are met. An auditor is configured to control a user's anonymity using a prime-order cryptographic group based encryption scheme. Via an authentication component, the auditor verifies that a pseudonym corresponding to the user's identity was encrypted correctly. If valid, the auditor decrypts encrypted pseudonym data using a private cryptographic key based upon the prime-order cryptographic group

### BACKGROUND

Organizations are increasingly looking to securely identify users who access and utilize their services and resources, both on the Internet and offline, while keeping these users' information private from everyone else. These user authentication and data sharing needs are driven by cost and efficiency considerations, by new business models that leverage personal information, and by the explosive rise of phishing, identity theft, and other security threats. Conventional mechanisms for user authentication and data sharing, such as plastic cards and paper certificates, are costly, vulnerable to counterfeiting, and problematic for online use.

As a result, there is a rapidly growing interest in mechanisms (e.g., X.509 certificates) that can be implemented in software and/or hardware and employed to secure monetary or financial transactions over the Internet. However, these mechanisms are limited because, for example, they cannot be used without disclosing at least some information associated with the user. During a verification procedure, in order to determine whether a given credential is valid, the user has to provide at least some identity data in order to be authenticated.

Even if some conventional mechanisms are capable of retaining anonymity, there are other concerns that cause problems with their use. In some cases, a relying party, such as a provider of goods/services, may desire to identify a particular user whose credential is illegitimate, such as when the user may be no longer qualified to use previously issued credentials, the attributes contained therein have become temporarily or permanently invalid, or the user violated policies associated with the service provider. While service providers, for instance, desire users to be identifiable for fraud prevention, these users seek to limit public exposure by controlling/minimizing information disclosed about them.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards achieving data security and privacy via identity escrow management. In one aspect, technology implementing identity escrow management permits trusted users to anonymously access online services/resources while ensuring providers of these services/resources (e.g., relying parties) that online transactions are secure from user misbehavior, including fraud. It is appreciated, however, that such misbehavior is not limited to fraud and may involve any inappropriate request/activity, such as a terms of service violation. If the user misbehaves in some respect, an auditor component de-anonymizes that user and if necessary, prevents future access to any online resource/service.

In one aspect, an identity management system and an auditor are configured to provide identity escrow management by implementing a cryptographic encryption scheme. Using this encryption scheme, according to one aspect, one or more components of the identity management system select one or more credentials to be pseudonyms capable of resolving the user's identity. One component, an identity escrow prover, encrypts each pseudonym using a private cryptographic key based on the prime-order cryptographic group. To prevent the user from encrypting junk data instead of the actual pseudonym, the identity prover, generates a proof of consistency between a commitment to the pseudonym and the pseudonym in encrypted form.

In one aspect, another component, an identity escrow verifier, validates this proof and the authenticity of the pseudonym. If this proof is valid, the pseudonym was encrypted correctly in accordance with the cryptographic encryption scheme. When combined with a presentation proof used for a minimal disclosure credential's validation, the cryptographic encryption scheme is provably secure against ciphertext malleability. When the auditor checks the presentation proof before decryption, any mauling of the encrypted pseudonym would be detected causing a failure.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating example identity escrow management architecture according to one example implementation.

FIG. 2 is a block diagram illustrating an example protocol for identity escrow management according to one or more example implementations.

FIG. 3 is a flow diagram illustrating example steps for securing a minimal disclosure credential with a pseudonym according to one example implementation.

FIG. 4 is a flow diagram illustrating example steps for de-anonymizing a minimal disclosure credential according to one example implementation.

FIG. 5 is a flow diagram illustrating example steps for issuing minimal disclosure credentials configured with a pseudonym for identity escrow management according to one example implementation.

FIG. 6 is a block diagram representing example non-limiting networked environments in which various embodiments described herein can be implemented.

FIG. 7 is a block diagram representing an example non-limiting computing system or operating environment in which one or more aspects of various embodiments described herein can be implemented.

### DETAILED DESCRIPTION

Various aspects of the technology described herein are generally directed towards identity escrow management in a computing environment. Identity escrow management may be implemented in computing environments where end-end transaction auditing is required and/or where user tracking is prohibited by regulation or otherwise undesirable. Identity escrow management balances opposing concerns of relying parties (e.g., service providers) who desire to identify users suspected of perpetrating fraud and of users who desire to limit tracking of their online activities and minimize disclosure of their information. Example implementations of identity escrow management enable user anonymity, but when appropriate, permit disclosure of the user's identity to certain entities, such as law enforcement and/or the relying parties. Disclosure typically occurs under proper circumstances, such as system abuse or requests from law enforcement.

In one or more example implementations, identity escrow management refers to enabling a credential to be anonymously presented to the relying party by encrypting a credential holder's identity escrow pseudonym and presenting that pseudonym in encrypted form to the relying party. If needed, the credential holder's identity can be de-anonymized by decrypting the credential holder's pseudonym and accessing identifying information that corresponds to that pseudonym. An auditor manages a private key for decrypting the credential holder's identity and prevents other hardware/software components from accessing that private key, securing the credential holder's identity from misappropriation/corruption.

A number of cryptographic encryption schemes may be configured to provide identity escrow management for various embodiments of secure credentials, which include minimal disclosure or anonymous credentials. These credentials generally enable the user with initiate secure transactions while disclosing little or no identifying information about the user. Even though certain information (e.g., attributes) is withheld from the relying party, a presentation proof based upon such an encryption scheme is configured to prove that these credentials correctly identify the user and remain valid. Implementing identity escrow for this presentation proof renders these credentials compatible with service providers that desire accountability when executing transactions online. Furthermore, combining the presentation proof with identity escrow management results in a semantically secure cryptographic encryption scheme.

One example embodiment implements identity escrow management as a component of Identity Management as a Service (IdMaaS), which may be platform configured to provide private/public/hybrid cloud computing services to manage identity relationships for an organization's employees, partners and customers in order to efficiently connect members of the organization's social graph to each other and to their applications and data. Another example embodiment employs Microsoft® Azure™ Active Directory® to build an IdMaaS platform with built-in support for the organization's internal users (e.g., employees, members, students). one example Microsoft® Azure™ Active Directory® service component extends IdMaaS to external users (e.g., customers, service providers, suppliers, partners and other relying parties), automates federation trust management, information security and user privacy.

One example cryptographic encryption scheme for issuing/verifying credentials may be implemented as a protocol gateway service where user tracking is disabled. To prevent user tracking, the Microsoft® Azure™ Active Directory® service—which resides between the user, relying party and an identity provider and operates as an issuer and verifier—disables end-to-end visibility on the user's actions. The role of the auditor is performed by one or more components external to that Microsoft® Azure™ Active Directory® service. For example, the Microsoft® Azure™ Active Directory® service should not be able to see that a person uses his/her Microsoft® Account (e.g., the Identity Provider), to log into a Skype® web server (e.g., a service provider operating as the relying party). When this person gets a credential from the identity provider, the Microsoft® Azure™ Active Directory® service maps this credential to a minimal disclosure credential comprising equivalent attributes.

When the person makes use of their credential, a proof of possession is generated, and sent to the relying party, who in turn forwards that proof to the Microsoft® Azure™ Active Directory® service for verification. The unlinkability of the minimal disclosure credential issuance and verification ensures that the Microsoft® Azure™ Active Directory® service does not have enough information to track users end-to-end. The Microsoft® Azure™ Active Directory® service may acknowledge that the person acquired the credential from the Microsoft® account and later observe that some user logged into the Skype® website, but the Microsoft® Azure™ Active Directory® service cannot correctly correlate these two incidents without great difficulty.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and computing security in general.

FIG. 1 is a block diagram illustrating an example identity management system according to one or more example implementations. One example component of the identity management system includes a prover 102 configured to negotiate secure credentials with an issuer 104 on behalf of a user and then, exchange transaction related data with a relying party by proving validity of these credentials via requests directed to a verifier 106. The issuer 104 generally refers to an authoritative source of cryptographic information, including public/private cryptographic keys and secure credentials, for user computers being managed by the identity management system. The prover 102 running on, for example, a user computer provides the issuer 104 with various data that, once authenticated, is returned as secure attribute data encoded within a credential 108, which may be herein referred to as a minimal disclosure credential. To illustrate one example, the credential 108 may be stored within a device (e.g., a smartcard, a mobile phone, or an online server).

The verifier 106 generally refers to a trusted hardware/software mechanism running within a computing device that provides the relying party with various services, including credential validation, identity escrow management, and so forth. The verifier 106 may use a variety of hardware/software components to achieve such identity escrow management, including an identity escrow verifier as described herein. As one example, in order to secure a transaction initiated with some service provider, the verifier 106 processes an authentication component 110 provided by the prover 102 that is configured to prove validity of the credential 108 and, if appropriate, provide a mechanism for de-anonymizing the user who submitted the credential 108.

The credential 108 generally may include encoded attribute data, such as identity data (e.g., a full name, a social security number (SSN), and/or the like), in addition to various other data. The prover 102 may configure the credential 108 to encode a different portion of the attribute data such that the user can selectively disclose certain attributes or if desired, disclose no attributes at all. The issuer 104, according to one example implementation, configures for the credential 108 one or more public/private keys using various data, such as another cryptographic key, which may be referred to as a secret key or a private key, the encoded attribute data and/or elements of a prime-order cyclic group. One example implementation of the credential 108 comprises an identity escrow pseudonym, which may be herein referred to as a pseudonym for clarity, in addition to various cryptographic data.

As described herein, a pseudonym 112 refers to a value capable of identifying the user as a consequence of inappropriate user activity. The pseudonym is computed using an attribute encoded within the credential 108 as a value indecipherable to anyone except to an auditor 114. The undisclosed attribute may include a unique user identifier or other data corresponding to the user's identity. This attribute may be herein referred to as an identity escrow attribute and may be encoded using an element of the prime-order cryptographic group. An encrypted form of the pseudonym 112, via a public cryptographic key generated by the auditor 114, may be herein referred to as encrypted pseudonym data. It is appreciated that any attribute encoded within the credential 108 may be encrypted and used as the encrypted pseudonym data.

As described herein, if the user requests access to some service provider, the verifier 106 evaluates the credential 108 with the authentication component 110 and/or other data to determine whether to grant or deny the user's request while keeping the user anonymous and holding that user accountable for inappropriate activities. The credential 108 does not disclose the pseudonym 112, except in encrypted form, which may include a considerably large mathematical number or construct, but does enable de-anonymization whereby the identity of the user or the user's organization or device is revealed to the verifier 106.

A portion of the authentication component 110 constitutes a presentation proof-of-possession of the private key of the prover 102 as well as a digital signature of the user on transaction-related data in which the digital signature is verifiable via a number of cryptographic mechanisms, including via an application of a public key or private key or via a comparison with a hash challenge. Hence, the presentation proof operates as a verifiable digital signature on the transaction-related data (e.g., messages). The authentication component 110 also includes an identity escrow proof-of-consistency, or consistency proof, between a commitment to the pseudonym 112 and the pseudonym 112.

The issuer 104 and the prover 102 negotiate public parameters in accordance with a prime-order group construction without bilinear pairings; and based upon these parameters, the issuer 104, or a separate authority, generates the credential 108 having a format that includes identifiers, a public key encoding attribute data and a digital signature comprising signed values and response values according one example embodiment.

One example parameter established between the issuer 104 and the prover 102 includes a group [symbol] construction selection. If the example parameter specifies a subgroup construction, group [symbol] 's description (p, q, g) specifies a subgroup of prime order q of a finite field of order p. Both p and q are prime numbers, q divides p−1, and g is a generator of [symbol] . Another example parameter specifies a group construction based upon elliptic curve cryptography over a prime field [symbol] ₚ, group [symbol] 's description (p, a, b, g, q, h) specifies an elliptic curve over a finite field [symbol] ₚ, where p is a prime number, a and b are two field elements defining the elliptic curve, g is a base point (gₓ, g_{y}) of prime-order q on the curve (and the generator of [symbol] _{q}), q is the order of the group, and h is the cofactor of the curve. These group constructions may form a basis for generating cryptographic groups and primitives.

The following steps describe one example implementation of the identity escrow management. At an initial setup step, the auditor 114 generates cryptographic data 116, including cryptographic key pairs of public/private keys. One example implementation of the auditor 114 generates an El Gamal encryption key pair during the setup phase. The group parameters of this key pair should match the issuer parameters. The group is denoted by G, the prime order of G by q, and the generator used for the El Gamal encryption scheme is denoted as g. The element g will be re-used from the group parameters for the issuer 104. The auditor also establishes a policy 118 defining under which conditions the user may be de-anonymized.

An issuance step refers to executing a protocol by which the credential 108 is issued by the issuer 104. Via a presentation step, the auditor 114 encrypts the identity escrow attribute as the pseudonym 112 and generates an identity escrow proof using a commitment to the pseudonym 112 that proves validity of the pseudonym 112. The verifier 106, during a verification step, may verify that the pseudonym 112 is valid after determining that the presentation proof also is valid. If minimal disclosure credential abuse occurs, the auditor 114 decrypts the pseudonym 112, under certain conditions, on behalf of the verifier 106.

The following provides additional details for configuring identity escrow management as a separate independent computing mechanism that accepts as input the commitment to attribute x_{b}, denoted Cₓ_{_{b}}, and produces a ciphertext encrypting the pseudonym P_{E}=g^{x}^{_{b}} where g is the group generator along with the identity escrow proof that P_{E} is consistent with Cₓ_{_{b}}. The commitment Cₓ_{_{b}} comprises at least a portion of the presentation proof and the identity escrow attribute x_{b}. To correctly encrypt the pseudonym, the prover 102 employs an authentic copy of auditor public cryptographic El Gamal key H of and the policy 118. Note, the issuer 104 should not act as an authority to certify H since seperating the issuer 104 and the auditor 114 is a goal. Distributing H with authenticity may be done, for example, with a certificate authority (CA/PKI), or H may be embedded in prover devices, or distributed as part of software package for interfacing with the auditor 114.

The prover 102 and/or the auditor 114 cooperatively compute the identity escrow proof, which is defined as follows:

PK{(x_{b},r):E₁=g^{r} [symbol] E₂=g^{x}^{_{b}}H^{r} [symbol] x_{b}εAᵢ}

The ciphertexts E₁ and E₂, along with the above proof, and the presentation proof where attribute x_{b} is not disclosed comprise the authentication component 110 communicated to the relying party. The identity escrow proof of the authentication component 110 proves to the relying party that the ciphertext E₂ is an encryption of this attribute and the ciphertext E₁ is an encryption of a prime-order cryptographic group base element or generator g. Encrypting the pseudonym 112 in this manner may be referred to as verifiable encryption, since the relying party can verify some property of the pseudonym 112 without possessing the private cryptographic key for decryption. For example, the verifier 106 may determine that the credential is valid because the ciphertexts were computed correctly and the credential is an attribute of the minimal disclosure credential. The verifier 106 may use the auditor 114 to check the identity escrow proof of consistency of the pseudonym 112 before any decryption to determine whether the encrypted pseudonym 112 was adversely compromised/modified.

FIG. 2 is a block diagram illustrating an example protocol for identity escrow management according to one or more example implementations. The example system is an alternate implementation of the exemplary system described with respect to FIG. 1. Parties involved in the example protocol include an identity management system 202, an auditor 204, a user computing device 206 and an identity provider 208. It is appreciated that other parties may be recruited at any operation prescribed by the example protocol.

The identity management system 202 may be implemented as a network or cloud computing resource in which an issuer generates various cryptographic data, including cryptographic keys based upon prime-order cyclic groups and other cryptographic primitives. Example architectures of the identity management system 202 include Microsoft® Windows® Live Id and Microsoft® Windows® Azure™ Active Directory® Federation Service in which a trusted Security Token Service (STS) authenticates users and then, issues credentials to access other relying services. One embodiment of the identity management system 202 may be an integrated service over the network or cloud-computing resource, such as the Microsoft® Windows® Azure™ Active Directory®.

The identity management system 202 may also implement a revocation authority for managing blacklists and/or whitelists comprising revoked and/or valid minimal disclosure credentials, respectively. By operating a designated-verifier revocation authority for accumulator-based cryptographic schemes, according to one example implementation, a designated-verifier property of the identity management system 202 provides another level of privacy.

The service provider includes various online (i.e., Internet) properties that employ minimal disclosure credential technology to protect information stored within computer data. The identity management system 202 configures a verification mechanism, herein referred to as a verifier, to run on a service provider's system and validate user-submitted credentials. The verifier performs minimal disclosure credential validation by evaluating a digital signature to determine whether the credential was generated using the issuer's cryptographic key. In addition, the digital signature may be used to determine membership or non-membership in either a group of revoked user identities or valid user identities.

The user employs minimal disclosure credential technology in order to selectively disclose attribute information and still be permitted access to services provided by a relying party. The identity provider 208 may include a licensing department that creates user identities. In conjunction with the identity management system 202, the identity provider 208 generates a minimal disclosure credential using various user data and issues the minimal disclosure credential to the user. As described herein, the minimal disclosure credential may be presented with any combination of the user's data in the form of encoded attributes, such a Vehicle Identification Number (VIN), car make/model, credential identifier, owner name, driver's license number and/or the like. Regardless of which attribute, if any, the user desires to disclose, the licensing department configures the credential with an encoding of all these attributes.

According to one or more example implementations, the identity management system 202 is communicably coupled with one or more auditor components, such as an identity escrow verifier 210 and an identity escrow prover 212, which auditor 204 to de-anonymize the minimal disclosure credential and identify the user via decrypting encrypted pseudonym data. The identity escrow verifier 210 runs on the service provider's system and operates in combination with the verifier of the identity management system 202 as described herein. The identity escrow prover 212 runs on the user computing device 212 and operates in combination with a prover of the identity management system 202 as described herein.

As depicted by FIG. 2, one example implementation of the example protocol executes a sequence of at least eight identity escrow management operations where each operation corresponds to specific chronological point in time. Each operation's label is an encircled number representing that operation's sequence position.

Operation one (1) represents a setup phase of the example protocol where the identity management system 202 generates a cryptographic group, such as a prime-order cyclic group, defined as a group G in which the prime order of G is denoted by q and an element known as a generator is denoted by g and used for the auditor's encryption scheme. One example implementation of the identity management system 202 generates the cryptographic group G without any pairings, such as a bilinear pairing. The element g may be stored in and accessed from the issuer's parameter data 214.

According to one example implementation of operation one (1), an issuer component of the identity management system 202 initiates the example protocol by generating the parameter data 214, including cryptographic data for securing transaction data. Generating setup parameters results in at least a set of cryptographic group elements (g₀, g₁, . . . , g_{b}, . . . , gₙ, gₜ), where 1≦b≦n. The setup parameters also include public/private cryptographic keys for issuing minimal disclosure credentials that are hereinafter referred to as issuance keys. The issuer component, for example, generates a private key y₀ε [symbol] _{q}, and the corresponding public key (g₀, g₁, . . . , g_{b}, . . . , gₙ, gₜ) where g₀=g^{y}^{₀}.

Using the parameter data 214, according to one example implementation, the identity escrow prover 210 generates a private key x, at random, from a prime-order group [symbol] _{q}, computes a public key H=gₑ^{x} and designates the private and public cryptographic keys for identity escrow management. It is appreciated that the present disclosure may refer to the private key x as an auditor private cryptographic key and vice versa. Although the above key pair may constitute an El Gamal cryptographic key pair, it is appreciated that the present disclosure envisions other encryption schemes. As the identity escrow prover encrypts each user's pseudonym data, one example implementation of operation one (1) records identity escrow data 216 delineating each pseudonym and identifying information for each pseudonym user. The identity management system 202 may maintain the identity escrow data 216 on behalf of the identity escrow prover 210 or, alternatively, the identity escrow prover 210 maintains a separate independent copy of the identity escrow data 216. The identity escrow prover 210 may retain total sole control over the identity escrow data 216.

One example implementation of the auditor 204 creates a policy describing conditions permitting the de-anonymization of a minimal disclosure credential and disclosure of user information. When the verifier requests such de-anonymization, the verifier also communicates information demonstrating satisfaction of at least one of these conditions. The policy also establishes certain settings and/or ciphertext values for the identity escrow verifier 212 to use when determining validity of the pseudonym. The policy, for instance, may establish which components are to be included in a consistency proof for the pseudonym.

At operation two (2), a user, via the user computing device 206, obtains certain credentials from the identity provider 208. To illustrate one example, the user may login into web server associated with the identity provider 208 by using a valid password. The user may perform such authentication after being redirected from the identity escrow verifier 210. For instance, when browsing commercial web properties and initiating transactions, the identity escrow verifier 210 may secure these transactions by transferring the user to the identity management system 202, which in turn redirects the user to the identity provider 208 for authentication.

The identity provider 208 assigns various data, including a unique identifier, to the user computing device 206 and at operation three (3), shares each value with the identity management system 202, including the unique identifier's value. The identity provider 208 may submit such data as claims for minimal disclosure credential issuance. The unique identifier may be used an identity escrow attribute 218 configured for identifying the user after de-anonymization.

One example prover component for the identity management system 202, known as a prover 212, may select the unique identifier to be the identity escrow attribute 218. The identity management system 202 may store the unique identifier in the identity escrow data 216. As an alternative mechanism, the identity provider 208 does not disclose the unique identifier with the identity management system 204; instead, one example implementation of the prover 212 communicates an identity escrow pseudonym 220 for minimal disclosure credential issuance.

At operation four (4), the issuer component of the identity management system generates and issues minimal disclosure credentials for the user computing device 206 using information provided by the identity provider 208 and/or the prover 212. The issuer component encodes such information as attributes in each minimal disclosure credential. As an example, the issuer component employs a cryptographic hash function UID to compute a hash value, representing one example identity escrow pseudonym 220 that the user can recruit to obtain access to the identity escrow verifier 210. As another example, the issuer transforms the value of the identity escrow pseudonym 220 into a binary encoding of an unsigned integer in big-endian byte-order, which must be smaller than q to be a valid element of multiplicative subgroup [symbol] _{q}*.

According to one example implementation, the prover 212 reserves one of the minimal disclosure credential attributes for identity escrow, i.e., the identity escrow attribute 218, which is denoted x_{b}. The prover 212 may select the value x_{b} at random and define the identity escrow pseudonym 220 as P_{E}=g^{x}^{_{b}}. At operation four (4), the user receives a minimal disclosure credential encoding P_{E} as a pseudonym and stores the minimal disclosure credential in the user computing device 206. Optionally, the minimal disclosure credential may be stored in a separate device coupled to the user computing device 206.

While the identity escrow attribute 218 refers to the user or the user's organization, the identity management system 202 cannot decipher the user's identity from the identity escrow pseudonym 220 labeled P_{E} without great difficulty. Hence, the identity escrow pseudonym 220 provides anonymity for the identity escrow attribute 218. Excluding the user computing device 206, the auditor 210 is capable of resolving the user's identity.

Choosing a different attribute x_{b} value for each minimal disclosure credential limits the damage caused by auditor compromise, since transactions will only be linkable by the issuer. If a single x_{b} value is used for each of the user's minimal disclosure credentials, then P_{E} is the same for all presentation proofs, allowing them to be linked, given the auditor's secret cryptographic key. To simplify storage and management of one x_{b} value per credential, x_{b} can be computed as a function of the minimal disclosure credential's secret cryptographic key (and other credential-specific information, like an index/counter). The issuer may maintain database of all the P_{E} values corresponding to a given identity.

The issuer component may know P_{E} but may or may not know x_{b}. For example, by using a collaborative issuance feature or by contributing gᵢ^{x}^{ᵢ} for attribute i instead of xᵢ. This prevents a dishonest issuer from misappropriating as the prover 220 if that issuer knows attribute x_{b}. The issuer maintains an identity escrow table of (P_{E}, ID), so when presented a P_{E} value later by the identity escrow verifier 212, the issuer may look up the true identity associated with the pseudonym. In an alternative implementation where the issuer does not store such a table, the attribute x_{b} is chosen from a relatively small set of possible values (e.g., of size less than 2⁶⁰), that uniquely identify the user, such as a social security number. This allows log_{g} P_{E} to be computed, revealing x_{b} and identifying the user.

During one example implementation of operation five (5), the identity escrow prover 210 processes the identity escrow pseudonym 220 and using a commitment 222 to the identity escrow pseudonym 220, encrypts the identity escrow pseudonym 220 with the auditor's public key H to generate encrypted pseudonym data. The identity escrow prover 210 also computes a hash challenge and responses for generating a consistency proof 224 configured to verify that the commitment 222 was computed using identity escrow pseudonym 220, which proves integrity and authenticity of the encrypted pseudonym data.

One example implementation of the prover 212 executes operation five (5) after minimal disclosure credential presentation proof generation where x_{b} is a committed undisclosed attribute in addition to being the identity escrow attribute 218. The prover 212 may define the commitment 222 as Cₓ_{_{b}}=g₀^{x}^{_{b}}g₁^{o}^{_{b}} where opening o_{b} and attribute x_{b}, along with the presentation proof and the parameter data 214, are input to the audit prover 210 for generating the consistency proof 224. The following represents example steps for the operation five (5):
1. Encrypt
   a. Choose r at random from Z_{q}
   b. Generate ciphertexts E₁=g^{r}, E₂=g^{x}^{_{b}}H^{r}.
2. Generate Proof of Consistency
   a. Choose x_{b}′, r′ and o_{b}′ at random from Z_{q}.
   b. Compute Cₓ_{_{b}}′=g₀^{x}^{_{b}}^{′}g₁^{o}^{_{b}}^{′}, E₁′=g^{r′}, and E₂′=gₑ^{x}^{_{b}}^{′}H^{r′}.
   c. Compute hash challenge c=H(UIDₚ, g₀, UID_{T}, H, Cₓ_{_{b}}, E₁, E₂, Cₓ_{_{b}}′, E₁′, E₂′).
   d. Compute responses: rₓ_{_{b}}=x_{b}′−cx_{b}, rᵣ=r′−cr, rₒ_{_{b}}=o_{b}′−co_{b} (all mod q).
3. Output: (E₁, E₂, c, rₓ_{_{b}}, rᵣ, rₒ_{_{b}})

The first three fields of the hash challenge c,UID_{P},g₀,UID_{T}, serve to uniquely identify the issuer parameters of the parameter data 214, the issuer component, and the minimal disclosure credential (respectively). One example implementation generates the hash challenge c with additional information to be authenticated. Examples of such additional information may include the entire presentation proof, a certificate for the public key H and/or the like.

At operation six (6), the user presents the minimal disclosure credential to the identity escrow verifier 210 with a presentation proof and a consistency proof, such as the consistency proof 224, for the identity escrow pseudonym 220.

At operation seven (7), the identity escrow verifier 210 communicates the minimal disclosure credential and the proof 224 to the identity management system 202 for verification and if appropriate, decryption. One example implementation of operation eight (8) is run after the presentation proof is successfully verified by the identity management system 202 during operation seven (7). Inputs to the identity escrow verifier 212 include the credential T, the issuer parameters IP, the presentation proof which contains the commitment 222 Cₓ_{_{b}}, and the consistency proof 224 (E₁, E₂, c, rₓ_{_{b}}, rᵣ, rₒ_{_{b}}). Since the presentation proof is determined to be valid, the identity escrow verifier 212 can assume that Cₓ_{_{b}} is a valid commitment to x_{b}. The following steps represent one example implementation for determining whether the commitment 222 is consistent with the identity escrow pseudonym 220:
1. Verify that the encrypted pseudonym data (ciphertexts E₁, E₂) are valid elements of group G.
2. Verify that c and the response values have the correct length.
3. Compute Cₓ_{_{b}}″=(g₀^{r}^{_{xb}}g₁^{r}^{_{ob}})(Cₓ_{_{b}})^{c}, E₁″=(g^{r}^{ᵣ})(E₁)^{c}, and E₂″=(g^{r}^{_{xb}}H^{r}^{ᵣ})(E₂)^{c}.

4. Compute c′=H(UIDₚ, g₀, UID_{T}, H, Cₓ_{_{b}}, E₁, E₂, Cₓ_{_{b}}″, E₁″, E₂″).

5. Output valid if c′=c, and invalid otherwise.

Note, step number 3 uses response rₓ_{_{b}} to prove that the same value is used in computing ciphertext E₂ and the commitment 222 Cₓ_{_{b}}.

To de-anonymize the user, the verifier component sends the presentation proof, the minimal disclosure credential, and the consistency proof 222 to the identity escrow verifier 212. At the very least, the identity escrow verifier 212 may determine when the proof was created and which relying party was presented with this proof.

Instead of trusting the identity escrow verifier 210 to decide when to de-anonymize, which leaves open the potential for abuse, the decryption policy prescribes situations when it is appropriate decrypt the encrypted pseudonym data. If the presentation proof is valid, and the request satisfies the decryption policy, the identity escrow verifier 212 executes the following steps to ensure that the ciphertext is valid, and consistent with the proof 224. If valid, the identity escrow verifier 212 decrypts the encrypted pseudonym data, represented by ciphertexts (E₁, E₂), and obtains the identity escrow pseudonym 220 by computing the following expression:

$${P}_{E} = \frac{{E}_{2}}{{E}_{1}^{x}}$$

FIG. 3 is a flow diagram illustrating example steps for securing a minimal disclosure credential with a pseudonym according to one example implementation. Various hardware/software components (e.g., components of the auditor 114 of FIG. 1) may be configured to perform the example steps. Step 302 commences the example steps and proceeds to step 304 where identity escrow data is purged and issue parameters are processed. Based on the auditor's de-anonymization policy, an issuer may regularly purge old identity escrow pseudonyms. For example, if the policy states that the identity may be revealed for a period of up to one month following the use of the credential, and the credential expires in one month, then the issuer should delete the table entry after two months.

Step 306 determines whether the issuer parameters define a prime-order cryptographic group with pairings or without pairings. If, for instance, the cryptographic group refers to particular set of cryptographic group constructions, such as a non-bilinear prime-order cyclic subgroup based upon a discrete logarithm assumption, step 306 proceeds to step 308. If the cryptographic group refers to a group construction with a pairing, such as bilinear pairing, step 306 proceeds to step 314.

Step 308 refers to configuring an El Gamal key pair based upon a prime-order cryptographic group. As described herein, one example issue parameter refers to defining cryptographic group G as a prime-order cyclic subgroup with prime order q and generator g. An El Gamal cryptographic key pair is (x, H=g^{x}), where x is secret and H is public. One alternative El Gamal based encryption scheme supports k-of-k threshold decryption in which the secret key x is shared additively as x=x₁+ . . . +xₖ, and the public key becomes H₁H₂ . . . Hₖ=H, where Hᵢ=g^{x}^{ᵢ}.

Instead of or in addition to identity escrow, the El Gamal cryptographic key pair may be used for general verifiable encryption of small values. For instance, zip codes or short timestamps may be encrypted with these keys, and decrypted by solving a discrete log. If the issuer only issues minimal disclosure credentials with small-sized attributes, decryption may be possible within a bounded amount of time.

Step 308 is directed to generating encrypted pseudonym data, which may be referred to as ciphertexts, using the auditor private cryptographic key. Generally, to encrypt a message m in G, the auditor chooses r at random in Z_{q} and computes ciphertexts (E₁,E₂)=(g^{r}, mH^{r}). When m is a pseudonym P_{E}, m has the form P_{E}=g^{x}^{_{b}} where g is a public base element, and x_{b} is a private value known to the party encrypting the pseudonym (e.g., a user and/or the auditor) as well as an attribute in a minimal disclosure credential, such as a U-Prove credential.

If, at step 306, it is determined that the cryptographic encryption scheme is based upon a cryptographic group construction with pairings, step 314 is executed. Step 314 refers to generating a cryptographic key pair using a cryptographic group with pairings. One example implementation of the scheme using cryptographic groups with a paring assumes DDH is hard in a group G₁ having an asymmetric pairing. Another example scheme is configured to be secure under decisional linear assumption (DLIN). When execution of step 314 completes, step 314 proceeds to step 310.

Step 310 generates encrypted pseudonym data by, for example, using a private key to encrypt an identity escrow pseudonym provided by a prover. The private key ensures that only auditor components are capable of decrypting the encrypted pseudonym data and producing the identity escrow pseudonym. Step 312 computes a hash challenge using a public key and/or additional data, which verifies authenticity and/or integrity of the encrypted pseudonym data, and proceeds to step 316. Step 316 returns a consistency proof to the prover that comprises the hash challenge and the encrypted pseudonym data and proceeds to step 318. This proof demonstrates consistency between the pseudonym used for the encrypted pseudonym data and the pseudonym associated with the minimal disclosure credential. Step 318 terminates the example steps depicted by FIG. 3.

FIG. 4 is a flow diagram illustrating example steps for de-anonymizing a minimal disclosure credential according to one example implementation. Various hardware/software components (e.g., components of the auditor 114 of FIG. 1) may be configured to perform the example steps. Step 402 commences the example steps and proceeds to step 404 where a request is processed.

Step 406 determines validity of a presentation proof with identity escrow, which includes a proof of consistency between the encrypted pseudonym data and a commitment to the identity escrow pseudonym. After applying an auditor public cryptographic key to the consistency proof, if the auditor verifies the identity escrow pseudonym, step 406 proceeds to step 408. If, at step 406, it is determined that the minimal disclosure credential is not valid because presentation proof with identity escrow cannot be verified, step 420 stops any pending transactions between the service provider and the user. For instance, the auditor may instruct the service provider to cancel the user's planned purchase due to inappropriate activities.

Step 408 refers to decrypting the encrypted pseudonym data using an auditor private cryptographic key. Step 410 represents a disclosure protocol selection for the decrypted pseudonym where step 410 may proceed to step 412, step 414, step 416 and/or step 418, including any combination of these steps. If step 410 selects a first disclosure protocol and performs step 412, the auditor sends P_{E} directly to the issuer, which may perform a lookup of the user. If step 410 selects a second disclosure protocol and performs step 414, the auditor sends P_{E} directly to the issuer who blacklists the user from obtaining further credentials and revokes any outstanding credentials issued to this user, but does not reveal the user's identity. Such credential revocation may be executed using dynamic accumulator based techniques.

If step 410 selects a third disclosure protocol and performs step 416, the auditor sends P_{E} back to a relying party, such as a service provider, who requests the user's identity from the issuer. If step 410 selects a fourth disclosure protocol and performs step 418, the auditor returns the user's identity using a copy of the issuer's database of (user identifier, P_{E}) values. Optionally, the auditor may have sole access to the identity escrow table where the user provides the auditor with values for a (user identifier, P_{E}) pair. Step 422 terminates the example steps depicted for FIG. 4.

FIG. 5 is a flow diagram illustrating example steps for issuing minimal disclosure credentials configured with a pseudonym for identity escrow management according to one example implementation. Various hardware/software components (e.g., the issuer 104 and/or the prover 102 of FIG. 1) may be configured to perform the example steps. Step 502 commences the example steps and proceeds to step 504 where parameter data is generated and attribute data is processed. The parameter data may include issuer parameters, such as cryptographic group parameters, defining a prime-order cyclic group construction for securing the attribute data. Generally, the attribute data is provided by a user who desires secure credentials (e.g., minimal disclosure credentials) for executing electronic transactions.

Step 506 determines whether or not to randomize the pseudonym when issuing a minimal disclosure credential. If the pseudonym is to be randomized, step 506 proceeds to step 508 where an issuer and/or a prover may select, at random, a group generator and/or an attribute for computing the pseudonym. In one example implementation, the prover selects any one of the attributes provided in the attribute data to the issuer. The prover may select a different attribute for each credential. In another example implementation, the prover may determine which attribute by computing a function of a credential private key and/or other credential information, such as an attribute index or a counter.

In an alternative implementation where the issuer does not record identity escrow data, the attribute x_{b} is selected from a restricted set of possible values (e.g., of size less than 2⁶⁰), that uniquely identify the user, such as a social security number. A generator scope for computing the pseudonym may be restricted in scope as well. Either mechanism allows log_{g} P_{E} to be computed, revealing x_{b} and identifying the user.

Alternatively, to achieve unlinkability with a corrupt auditor, the issuer may employ a fresh base generator element g_{b} for each minimal disclosure credential. One identity escrow attribute x_{b} may result in different identity escrow pseudonyms for a set of issued minimal disclosure credentials. For example, the issuer may select a fresh attribute y_{b} for each minimal disclosure credential and provide the user with g^{y}^{_{b}} of which the auditor uses to encrypt g^{y}^{_{b}} and g^{y}^{_{b}}^{x}^{_{b}}. The attribute x_{b} may be consistent across multiple minimal disclosure credentials.

If, at step 506, it is determined that the pseudonym is not be randomized, step 508 is omitted and step 510 is executed. Step 510 determines whether to generate a derived credential using a first credential from another issuer. If not, step 510 omits step 512 and proceeds to step 514, but if so, step 510 proceeds to step 512, which verifies the first credential. Step 514 is directed to accessing the identity escrow pseudonym g^{x}^{_{b}}, which may be achieved by computing a mathematical value for the identity escrow pseudonym g^{x}^{_{b}} or selecting the identity escrow pseudonym g^{x}^{_{b}} provided by the prover, and generating a minimal disclosure credential. As one example mechanism, the user may employ an identity escrow pseudonym g^{x}^{_{b}} that the issuer doesn't know by splitting and escrowing the pseudonym across at least two entities, such as the issuer and an identity provider.

If step 510 decides to generate the derived credential, step 512 verifies the first credential's authenticity and integrity. One example derived credential corresponds to an identity escrow pseudonym g^{x}^{_{b}} that is computed from an attribute of the first credential. After verifying the first credential, step 512 proceeds to step 514, which generates the derived credential based on the identity escrow pseudonym g^{x}^{_{b}} and other data corresponding to the first credential. Step 516 terminates the example steps described for FIG. 5.

In one or more example implementation, the identity escrow pseudonym g^{x}^{_{b}} may represent a user identifier that is not an attribute of a second credential. After a first minimal disclosure credential is used to decrypt the identity escrow pseudonym g^{x}^{_{b}}, the auditor reveals that value to the issuer who generates a second minimal disclosure credential with the identity escrow pseudonym g^{x}^{_{b}} as an attribute. For example, the issuer could issue a minimal disclosure credential with a credential acknowledging that the user has a valid driver's license, and subsequently, another minimal disclosure credential with a credential guaranteeing that if the user misbehaves, the user's driver's license number will be revealed. The identity provider retains the valid driver's license number and the issuer never learns that number unless the user violates an auditor encryption policy. Also, the issuer would need to know the list of possible driver's license numbers or rely upon the identity provider.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

FIG. 6 provides a schematic diagram of an example networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Example Computing Device

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the example computing system environment 700.

With reference to FIG. 7, an example remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, controlling anonymity of a minimal disclosure credential using a cryptographic scheme, including, processing a request to de-anonymize information associated with the minimal disclosure credential, the request comprising an authentication component corresponding to encrypted attribute data, and decrypting the encrypted attribute data using a private cryptographic key and the authentication component.

2. The method of claim 1 further comprising using a public cryptographic key to validate the authentication component, including validating a commitment to an identity escrow attribute of the minimal disclosure credential.

3. The method of claim 2, wherein using the public cryptographic key to validate the authentication component further comprises verifying a proof of consistency between the commitment and the encrypted attribute data.

4. The method of claim 3, wherein using the public cryptographic key to validate the authentication component further comprises computing a hash challenge for comparing with the proof of consistency, and determining whether the commitment was used to generate the proof of consistency.

5. The method of claim 1, wherein processing the request further comprises decrypting the encrypted attribute data to produce attribute data and verify that the attribute data was encrypted using a public cryptographic key and encoded within the minimal disclosure credential, the attribute data is restricted by size.

6. The method of claim 1, wherein processing the request further comprises determining whether the request satisfies a decryption policy.

7. The method of claim 1, wherein decrypting the encrypted attribute data further comprises decrypting the encrypted attribute data using the private cryptographic key based upon a prime-order cryptographic group.

8. The method of claim 1 further comprising at least one of accessing identity escrow data to determine identifying information about a user.

9. The method of claim 1 further comprising revoking a user identity corresponding to the minimal disclosure credential.

10. The method of claim 1 further comprising generating an El Gamal cryptographic key pair comprising a private cryptographic key and a public cryptographic key.

11. The method of claim 10 further comprising distributing the El Gamal key pair amongst a plurality of identity escrow provers running on user computers.

12. The method of claim 10 further comprising additively sharing the private cryptographic key and the public cryptographic key amongst a plurality of auditors.

13. In a computing environment, a system, comprising, an identity escrow prover configured to verifiably encrypt a pseudonym of a user and control user anonymity using a cryptographic scheme, wherein the identity escrow prover is further configured to process an identity escrow attribute of the minimal disclosure credential that corresponds to a pseudonym, accessing an auditor cryptographic key, encrypting the identity escrow attribute using the auditor cryptographic key, and generating a consistency proof between encrypted pseudonym data and the identity escrow attribute.

14. The system of claim 13, wherein the identity escrow prover is further configured to encrypt the identity escrow attribute using a prime-order cryptographic group.

15. The system of claim 13, wherein the identity escrow prover is further configured to generate a hash challenge for validating the pseudonym.

16. One or more computer-readable media having computer-executable instructions, which when executed perform steps, comprising:
processing at least one identity escrow pseudonym;
generating a set of minimal disclosure credentials using the at least one identity escrow pseudonym; and
recording the at least one identity escrow pseudonym in identity escrow data.

17. The one or more computer-readable media of claim 16 having further computer-executable instructions comprising:
generating each identity escrow pseudonym using an identity escrow attribute selected from a restricted set of user identifiers.

18. The one or more computer-readable media of claim 16 having further computer-executable instructions comprising:
selecting at least one of a prime-order cryptographic group generator or a minimal disclosure credential attribute, at random, for computing an identity escrow pseudonym.

19. The one or more computer-readable media of claim 16 having further computer-executable instructions comprising:
generating a first minimal disclosure credential using a first portion of an identity escrow pseudonym; and
generating a second minimal disclosure credential using a second portion of the identity escrow pseudonym.

20. The one or more computer-readable media of claim 16 having further computer-executable instructions comprising:
issuing a derived credential for an identity escrow pseudonym corresponding to an attribute of another minimal disclosure credential.
